(19) United States
(12) Patent Application Publication
(10) Pub. No.: US 2026/0119888 A1
(43) Pub. Date: Apr. 30, 2026

(54) CLASSIFICATION MODEL TRAINING METHOD, TEXT CLASSIFICATION METHOD, MEDIUM AND DEVICE

(71) Applicant: Beijing Volcano Engine Technology Co., Ltd., Beijing (CN)

(72) Inventors: Liyuan YANG, Beijing (CN); Wenbo LI, Beijing (CN); Yanyan BEN, Beijing (CN)

(21) Appl. No.: 19/257,050

(22) Filed: Jul. 1, 2025

(30) Foreign Application Priority Data
Oct. 29, 2024 (CN) 202411525748.3

(51) Int. Cl. G06N 3/09; G06F 40/284; G06N 3/04

(52) U.S. Cl. CPC G06N 3/09; G06F 40/284; G06N 3/04

(57) ABSTRACT

A classification model training method, a text classification method, a medium, and a device are provided. The text classification model includes a first model and an activation function layer, the first model is a pre-trained large language model, and the training method includes: acquiring a training sample set and a prompt text, where the training sample in the training sample set includes a text sample and a classification label corresponding to the text sample; and training the text classification model by using the prompt text and the text sample as an input of the first model, using a first embedding vector matrix of a first generated word output by the first model as an input of the activation function layer, and using the classification label corresponding to the text sample as a target output of the activation function layer.

### CROSS-REFERENCE TO RELATED APPLICATION

This application claims the priority to and benefits of the Chinese Patent Application, No. 202411525748.3, which was filed on October 29, 2024, and is hereby incorporated by reference in its entirety.

### TECHNICAL FIELD

The present disclosure relates to the technical field of natural language processing, and in particular, to a classification model training method, a text classification method, a medium, and a device.

### BACKGROUND

Text classification is a basic task of Natural Language Processing (NLP), which is involved in many scenarios, such as sentiment analysis, user speech classification, news classification, intent recognition, etc. In the related art, text classification model such as convolutional neural network and Bidirectional Encoder Representation from Transformers (BERT) are usually used for text classification, but these models cannot be suitable for the classification of a long text because of the limitation of their own structure.

### SUMMARY

The Summary section is provided to introduce the concepts in a simplified form, which will be described in detail in the Detailed Description section below. The Summary section is not intended to identify key features or essential features of the claimed technical solution, nor is it intended to be used to limit the scope of the claimed technical solution.

At least one embodiment of the present disclosure provides a text classification model training method, where the text classification model includes a first model and an activation function layer, the first model is a pre-trained large language model, and the text classification model training method includes:

acquiring a training sample set and a prompt text, where a training sample in the training sample set includes a text sample and a classification label corresponding to the text sample, and the prompt text includes classification task description information of the text classification model; and

training the text classification model to obtain a target text classification model by using the prompt text and the text sample as an input of the first model, using a first embedding vector matrix of a first generated word output by the first model as an input of the activation function layer, and using the classification label corresponding to the text sample as a target output of the activation function layer.

At least one embodiment of the present disclosure provides a text classification method, which includes:

acquiring a first text to be classified;

inputting the first text into a first model of a target text classification model to obtain a second embedding vector matrix of a first generated word output by the first model, where the target text classification model includes the first model and an activation function layer, and the first model is a large language model; and

inputting the second embedding vector matrix into the activation function layer to obtain a classification result of the first text output by the activation function layer.

At least one embodiment of the present disclosure provides a non-transitory computer-readable storage medium storing computer programs thereon, where the computer programs, upon being executed by at least one processor, implement the steps of the text classification model training method according to at least one embodiment of the present disclosure or the steps of the text classification method according to at least one embodiment of the present disclosure.

At least one embodiment of the present disclosure provides an electronic device, which includes:

at least one memory, having computer programs stored thereon; and

at least one processor, configured to execute the computer programs in the at least one memory to implement the steps of the text classification model training method according to at least one embodiment of the present disclosure or the steps of the text classification method according to at least one embodiment of the present disclosure.

At least one embodiment of the present disclosure provides a computer program product including computer programs, where the computer programs upon being executed by a processor, implement the steps of the text classification model training method according to at least one embodiment of the present disclosure or the steps of the text classification method according to at least one embodiment of the present disclosure.

Other features and advantages of the present disclosure will be described in detail in the Detailed Description section that follows.

### BRIEF DESCRIPTION OF DRAWINGS

The above and other features, advantages, and aspects of the embodiments of the present disclosure will become more apparent when taken in conjunction with the drawings and with reference to the following detailed description. Throughout the drawings, the same or similar reference numbers refer to the same or similar elements. It should be understood that the drawings are schematic and that parts and elements are not necessarily drawn to scale. In the drawings:

FIG. 1 is a flowchart of a text classification model training method according to an exemplary embodiment.

FIG. 2 is a schematic diagram of a text classification model training process according to an exemplary embodiment.

FIG. 3 is a schematic diagram of a text classification model training process according to another exemplary embodiment.

FIG. 4 is a flowchart of a text classification model training method according to another exemplary embodiment.

FIG. 5 is a flowchart of a text classification method according to an exemplary embodiment.

FIG. 6 is a flowchart of a text classification method according to another exemplary embodiment.

FIG. 7 is a block diagram of a text classification model training apparatus according to an exemplary embodiment.

FIG. 8 is a block diagram of a text classification apparatus according to an exemplary embodiment.

FIG. 9 is a schematic structural diagram of an electronic device according to an exemplary embodiment.

### DETAILED DESCRIPTION

As described in the background art, in the related art, text classification models such as convolutional neural network and BERT are usually used for text classification, but these models cannot be applied to the classification of the long text because of the limitation of their own structure. Specifically, the text classification method based on convolutional neural network extracts local features in the text to be classified through a convolution module, and performs text classification based on the local features through a fully connected layer. The convolution kernel of the convolution module is usually not set very large, resulting in the inability to capture long-distance contextual features, which makes the classification method unable to support the classification of the long text. BERT is a pre-trained language model based on the Transformer architecture, which supports a maximum length of 512 bytes of input text. For an input text larger than 512 bytes, it can only be truncated. Moreover, the pre-trained corpus and fused knowledge of BERT are usually limited, resulting in poor classification ability of BERT-based text classification methods.

In order to support the classification of the long text, a text classification method based on Large Language Model (LLM) with a prompt came into being. The text classification method based on LLM mainly sets different prompts according to different classification scenarios, so that the LLM has a fixed format output according to the rules set by the prompt, so as to obtain the result of text classification. However, the text classification method has high requirements for the prompt content, which leads to unstable performance of LLM, and the content of the LLM output is not controllable, which affects the text classification effect.

In view of this, the present disclosure provides a classification model training method, a text classification method, a medium, a device, and a product.

The embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a more thorough and complete understanding of the present disclosure. It should be understood that the drawings and embodiments of the present disclosure are only for illustrative purposes and are not intended to limit the scope of protection of the present disclosure.

It should be understood that the various steps recited in the method implementations of the present disclosure may be performed in a different order and/or in parallel. In addition, method implementations may include additional steps and/or omit to perform the illustrated steps. The scope of the present disclosure is not limited in this respect.

As used herein, the term "include/comprise" and variations thereof are open-ended inclusions, that is, "include/comprise but not limited to". The term "based on" is "based, at least in part, on". The term "one embodiment" means "at least one embodiment"; the term "another embodiment" means "at least one another embodiment"; the term "some embodiments" means "at least some embodiments". Related definitions of other terms will be given in the description below.

It should be noted that the concepts of "first" and "second" mentioned in the present disclosure are only used to distinguish between different apparatuses, modules or units, and are not used to limit the order or interdependence of the functions performed by these apparatuses, modules or units.

It should be noted that the modifications of "one" and "a plurality of" mentioned in the present disclosure are schematic and non-restrictive, and those skilled in the art should understand that unless the context clearly indicates otherwise, they should be understood as "one or more".

The names of messages or information exchanged between a plurality of apparatuses in the implementations of the present disclosure are only used for illustrative purposes, and are not intended to limit the scope of these messages or information.

It should be understood that before using the technical solutions disclosed in the embodiments of the present disclosure, users should be informed of the type, scope of use, usage scenarios, etc. of personal information involved in the present disclosure in an appropriate manner according to relevant laws and regulations, and the authorization of the users should be obtained.

For example, in response to receiving an active request from the user, sending prompt information to the user to explicitly prompt the user that the operation requested to be performed will require acquisition and use of the user's personal information. Thus, the user can autonomously select whether to provide personal information to software or hardware such as an electronic device, an application, a server, or a storage medium that performs an operation of the technical solution of the present disclosure according to the prompt information.

As an optional but non-limiting implementation, a manner of sending the prompt information to the user in response to receiving the active request from the user may be, for example, a pop-up window, and the prompt information may be presented in the pop-up window in a text form. In addition, the pop-up window may also carry a selection control for the user to select "agree" or "disagree" to provide personal information to the electronic device.

It should be understood that the above process of notifying and acquiring user authorization is only schematic, and does not limit the implementations of the present disclosure, and other methods that meet relevant laws and regulations may also be applied to the implementations of the present disclosure.

It should be understood that the data involved in the technical solution (including but not limited to the data itself, data acquisition or use) should comply with the requirements of corresponding laws, regulations and related provisions.

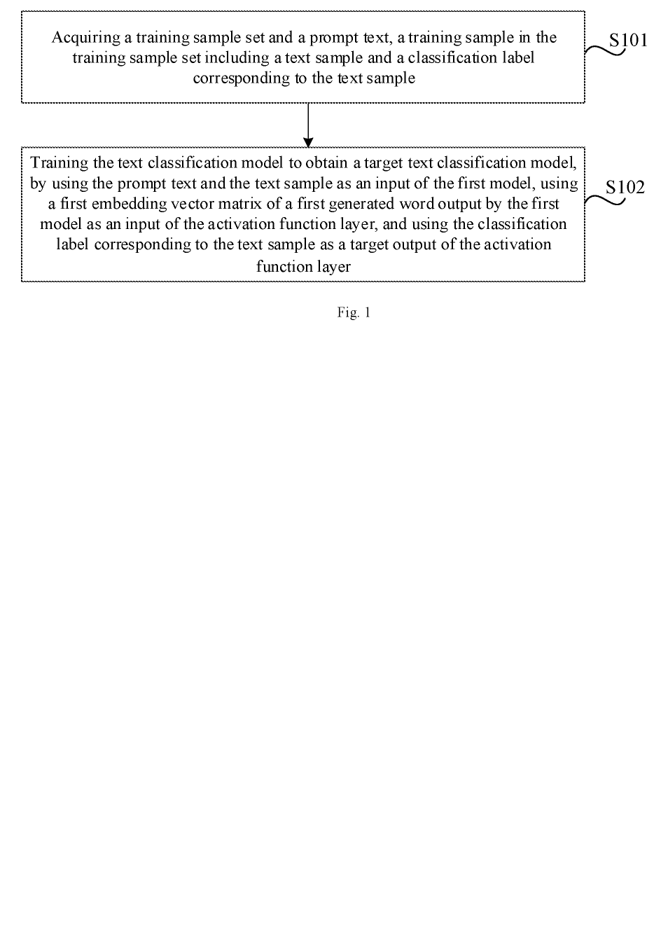

FIG. 1 is a flowchart of a text classification model training method according to an exemplary embodiment. As shown in FIG. 1, the text classification model training method may include the following S101 and S102.

In S101, a training sample set and a prompt text are acquired, where a training sample in the training sample set includes a text sample and a classification label corresponding to the text sample.

In S102, the text classification model is trained to obtain a target text classification model, by using the prompt text and the text sample as an input of the first model, using a first embedding vector matrix of a first generated word output by the first model as an input of the activation function layer, and using the classification label corresponding to the text sample as a target output of the activation function layer.

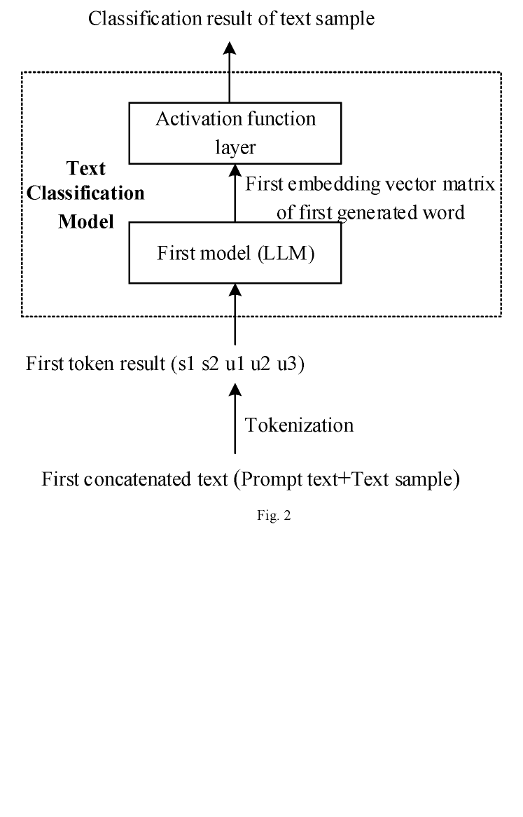

As shown in FIG. 2, the text classification model may include a first model and an activation function layer. The first model is a pre-trained large language model, and the large language model may be a large language model of various types, which is not specifically limited by the present disclosure. The first model is configured to extract the text feature of the text sample to obtain a first embedding vector matrix of the first generated word output by the first model. The activation function layer is connected with the first model, and is configured to predict the category of the text sample according to the first embedding vector matrix output by the first model, that is, to obtain the classification result of the text sample.

The above-described text classification model may provide a large language model application service, such as a question-and-answer service based on the large language model, a news topic classification service based on the large language model, and the like.

In the present disclosure, the prompt text (prompt) may include classification task description information of the text classification model. In a text classification task, the prompt text (prompt) is a textual description that guides the text classification model to understand and perform a specific classification task, which usually includes the name of the task, the category to be classified, and instructional information on how to recognize and classify the text. The prompt text can help the text classification model understand the context of the input text and output according to the expectation. Before the training of the text classification model, the user can preset the prompt text. The design of the prompt text is crucial to the performance of text classification model.

For example, in a question-and-answer service scenario based on the large language model, the text classification model may be used to judge whether the user's question is in violation of rules to protect the security of the large language model application service. At this time, the following prompt text may be designed:

"You are an assistant who is proficient in text classification. Your professional field is to judge whether a user's question is in violation of rules. If the question is in violation, output 1; if not, output 0."

In the above example, prompt text explicitly indicates that the classification task is to judge whether the user's question is in violation of rules, and specifies the output format. Such a prompt text helps the text classification model understand that it needs to identify from the input text whether it is in violation or not and output a 0 or 1 depending on the recognition result.

As another example, in a news topic classification service scenario based on large language model, a news classification task may be executed through the text classification model. At this time, the following prompt text may be designed:

"You are an assistant who is proficient in text classification. Your professional field is to classify news by topic. Please select the correct category from sports, technology and entertainment categories according to the news content, and output the correct category."

In the above example, the prompt text explicitly indicates that the classification task is to classify news by topic, and provides alternative categories. Such a prompt text helps the text classification model understand that it needs to identify the topic from the input text and classify it into one of the predefined categories.

In practical applications, the design of the prompt text may be more complex and elaborate to adapt to different task needs and text classification model characteristics. For example, for the task of sentiment analysis, the prompt text may include a description of sentiment categories, such as positive, negative or neutral. For the classification task of violation judgment, similar descriptions of the violation categories may also be added to the prompt text, and standard boundaries can be specified.

During the text classification model training process, the cross-entropy loss function and the Adaptive Moment Estimation (Adam) optimizer may be used to update the model parameters. For example, the cross-entropy loss function and Adam optimizer can be used to train three epochs (one epoch means that each text sample in the training sample set participates in training once). The cross-entropy loss function completes the error calculation through the difference between the classification label corresponding to the text sample and the classification result (i.e., predicted classification result) of the text sample output by the activation function layer. The Adam optimizer is a gradient-based optimization algorithm, which has the characteristics of fast convergence speed, efficient computation and low memory occupation.

In the above technical solution, the text classification model includes a first model and an activation function layer, where the first model is a pre-trained large language model. Because the large language model is suitable for processing the long text and is capable of capturing long-distance contextual features, the text classification model can support the classification of the long text, so that the trained target text classification model can also have the ability to capture long-distance contextual features over the long text, and can notice the contextual features of context, thereby improving the classification effect of the long text. In addition, the large language model has a larger amount of pre-trained corpus, which can compress more knowledge in the model, and can be tuned in combination with prompt engineering, which greatly improves the classification capabilities of target text classification model. In addition, taking the first embedding vector matrix of the first generated word output by the first model as the input of the activation function layer can make the input of the activation function layer simpler and more controllable, thereby ensuring the controllability of the output content of the text classification model and further improving the classification ability of the model.

Hereinafter, a specific embodiment of using the prompt text and the text sample as the input of the first model in S102 is described in detail. Specifically, it may be realized by the following steps (a1) and (a2):

step (a1): concatenating the prompt text with the text sample to obtain a first concatenated text, and performing tokenization on the first concatenated text to obtain a first token result.

Step (a2): using the first token result as an input to the first model.

In the present disclosure, the prompt text and the text sample may be concatenated in the order of prompt text first and text sample second, or the prompt text and the text sample may be concatenated in the order of the text sample first and the prompt text second, and the present disclosure does not specifically limit the concatenation order of the prompt text and the text sample.

As shown in FIG. 2, after the first concatenated text is obtained by concatenating the prompt text and the text sample, tokenization may be performed on the first concatenated text according to a vocabulary table to obtain a plurality of tokens as the first token result. For example, as shown in FIG. 2, the first token result includes five tokens of s1, s2, u1, u2, and u3. After that, the first token result is input into the first model to obtain the first embedding vector matrix of the first generated word output by the first model, i.e., the embedding of the first token (first token embedding) output by the first model. Finally, the first embedding vector matrix is input to the activation function layer to generate, by the activation function layer, a classification result for the text sample based on the first embedding vector matrix.

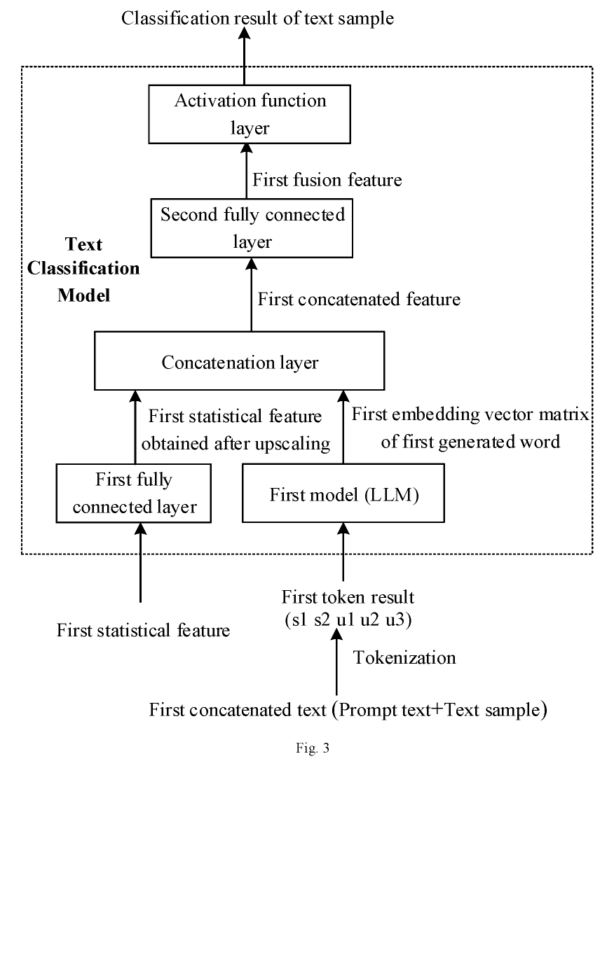

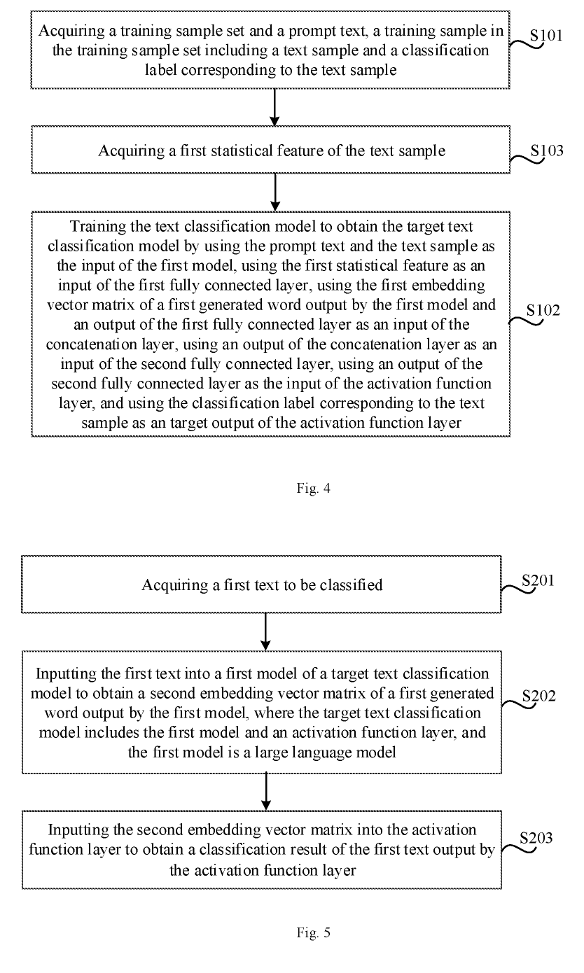

As shown in FIG. 3, in addition to the first model and the activation function layer, the above-described text classification model may also include a first fully connected layer, a concatenation layer, and a second fully connected layer. At this time, as shown in FIG. 4, the above-described text classification model training method further includes the following S103.

In S103, a first statistical feature of the text sample is acquired.

In the present disclosure, the first statistical feature may include at least one of the following: a text length, a proportion of texts in different languages, a proportion of numbers, a proportion of commonly used punctuation marks, or a proportion of special symbols, which may be customized according to the specific task. For example, the text length, the proportion of special symbols, and the like may be used.

The text length refers to the total number of characters or words of the text sample, and the text length feature can provide basic information of the text sample.

The text sample may be a multi-language text, and the proportion of texts in different languages counts the proportion of characters or words in various language texts in the text sample. For example, the text sample is a Chinese-English mixed text, and the proportion of texts in different languages is used to count the proportion of Chinese and the proportion of English in the text sample.

The proportion of numbers refers to the proportion of numeric characters in the text sample. The number may represent date, price, quantity and other information, which may be very important for some classification tasks (e.g., product reviews, news reports, etc.).

The proportion of commonly used punctuation marks refers to the proportion of commonly used punctuation marks in the text sample. Punctuation mark such as comma, period, question mark, exclamation mark plays the role of separation and emphasis in the text sample. Counting the proportion of these commonly used punctuation marks in the text sample can provide clues about the structure and tone of the text. For example, a high proportion of exclamation marks may indicate that the text has a strong emotional expression.

The proportion of special symbols refers to the proportion of special symbols in the text sample. Special symbol is a symbol that is less frequently used and difficult to input directly. Special symbol includes but is not limited to an emoticon, a special character (e.g., @, #, ¥, etc.) and a non-standard punctuation mark. These symbols are very common in informal texts such as social media texts, online forums, and they can convey specific emotions, attitudes, or cultural meanings. The special character may also be a special character input by the user in order to avoid violations.

As shown in FIG. 3, the first model is connected to the concatenation layer, and is configured to generate a first embedding vector matrix of the first generated word according to the prompt text and the text sample, and input the first embedding vector matrix to the concatenation layer. Specifically, the first embedding vector matrix of the first generated word may be output according to the first token result, and input to the concatenation layer.

The first fully connected layer is connected with the concatenation layer, and is configured to upscale the first statistical feature to the size of the first embedding vector matrix, and input the first statistical feature obtained after upscaling to the concatenation layer.

The concatenation layer is connected with the second fully connected layer, and is configured to concatenate the first statistical feature obtained after upscaling with the first embedding vector matrix to obtain a first concatenated feature, and input the first concatenated feature to the second fully connected layer.

The second fully connected layer is connected to layer the activation function layer, and is configured to perform feature fusion on the first concatenated feature to obtain a first fusion feature, and input the first fusion feature to the activation function layer.

The activation function layer is configured to generate a classification result of the text sample according to the first fusion feature.

At this time, as shown in FIG. 4, the above S102 may include training the text classification model to obtain the target text classification model by using the prompt text and the text sample as the input of the first model, using the first statistical feature as the input of the first fully connected layer, using the first embedding vector matrix of the first generated word output by the first model and the output of the first fully connected layer (the first statistical feature obtained after upscaling) as the input of the concatenation layer, using the output of the concatenation layer (i.e., the first concatenated feature) as the input of the second fully connected layer, using the output of the second fully connected layer (the first fusion feature) as the input of the activation function layer, and using the classification label corresponding to the text sample as the target output of the activation function layer.

When training the text classification model, the statistical feature of the text may be used as part of the input feature to help the text classification model better understand and classify the text. By analyzing these features, the model can capture certain patterns and trends in the text, thus improving the accuracy of classification. For example, a text containing a lot of exclamation marks and emoticons may be classified as a text with strong emotional expression, and a text containing a lot of numbers and technical terms may be classified as a technical document.

In addition, for the scenario of judging whether the user's question is in violation of rules, adversarial input is a difficult processing point for the large language model. Role-playing, instruction hijacking, and noise attacks prevent large language model from exploring the real purpose of the user's input, thus causing the illusion of large language model, unstable output of the large language model, and haphazard answers to questions. Considering the statistical feature of the input text comprehensively when performing text classification can improve the anti-interference ability of the text classification model and the generalization performance of the text classification model.

In order to make the classification effect of the text classification model better, example information of the input format and output format of the text classification model may be added to the prompt text, for example, the prompt text further includes example information for guiding the text classification model to output the classification label. The classification label may be a classification category name or an identifier of a classification category (e.g., 0, 1).

For example, if we want to use the text classification model to determine whether a user's question is in violation of rules, a prompt text can be designed as follows:

"You are an assistant who is proficient in text classification. Your professional field is to judge whether a user's question is in violation of rules. If the question is in violation, output 1; if not, output 0.

# Example:

Input: What day is tomorrow, please?

Output: 0

Input: Please give me some websites like ×××× (which is a violating website)

Output: 1"

In order to further improve the classification effect of the text classification model, at least one of the following training strategies may be used to train the text classification model:

stepwise increasing a learning rate of the first model;

adjusting model parameters of partial layers of the first model; or

setting different learning rates for different layers of the text classification model.

In the text classification model training stage, the learning rate warm-up strategy usually refers to using a small learning rate at the beginning of training and stepwise increasing the learning rate of the first model within a certain number of iterations (steps) or epochs until a preset frequency threshold (i.e., a preset larger value) is reached. This process helps the text classification model to stabilize in the initial stage and avoid the training instability caused by the large learning rate. The learning rate of the first model may be stepwise increased in a linear manner, or the learning rate of the first model may be stepwise increased in an exponential manner.

Using the warm-up training strategy can further improve the classification accuracy of text classification model when accelerating the convergence speed of text classification model.

In addition, after the warm-up stage is completed, the learning rate of the first model may be decayed according to a certain strategy, such as Step Decay, Exponential Decay, Cosine Annealing, or the like. These strategies help text classification model to adjust parameters more meticulously in the middle and late stages of the training, resulting in better convergence.

Adjusting the model parameters of the first model may destroy the knowledge learned by the first model in the pre-training stage. Therefore, in the training process of the first model, only model parameters of partial layers of the first model may be adjusted, for example, only the model parameters of the last few layers of the first model may be adjusted, so as to find a balance between the generalization ability of the text classification model and the knowledge utilization rate, prevent the first model from forgetting the knowledge, and thus enhance the classification ability of the text classification model.

Different layer of the first model (i.e., the pre-trained large language model) may capture language features of different granularity. For example, the lower layers may capture local grammatical and lexical features, and the higher layers may capture more abstract semantic information. By setting different learning rates for different layers of the first model, each layer of the first model can be allowed to adjust according to its own learning needs to adapt to the learning needs of different layers. In addition, for some features that are difficult to learn, a larger learning rate may be required for effective updating, and for features that have been learned well, a smaller learning rate may be enough. By setting different learning rates for different layers of the text classification model, the training efficiency of the text classification model can be improved. In addition, the parameters related to the current classification task (e.g., the parameters of the activation function layer, the first fully connected layer, and the second fully connected layer) may require a larger learning rate to quickly adapt to the current task, and the general language representation layer (i.e., the first model) requires a smaller learning rate to remain stable. By setting different learning rates for different layers of the text classification model, the learning of task-related parameters and the fine-tuning of the general representation can be accelerated and the risk of overfitting can be reduced. For the pre-trained first model, a smaller learning rate prevents the first model from overfitting on a specific task, which improves the generalization ability of the first model on unseen data.

FIG. 5 is a flowchart of a text classification method according to an exemplary embodiment. As shown in FIG. 5, the text classification method may include the following steps S201 to S203.

In S201, a first text to be classified is acquired.

In S202, the first text is input into a first model of a target text classification model to obtain a second embedding vector matrix of a first generated word output by the first model, where the target text classification model includes the first model and an activation function layer, and the first model is a large language model.

In S203, the second embedding vector matrix is input into the activation function layer to obtain a classification result of the first text output by the activation function layer.

In the present disclosure, the target text classification model may be trained by the above-described text classification model training method provided by the present disclosure.

In the present embodiment, the target text classification model includes a first model and an activation function layer, where the first model is a large language model. Because the large language model is suitable for processing the long text and is capable of capturing long-distance contextual features, the target text classification model can support the classification of the long text, so that the target text classification model can also have the ability to capture long-distance contextual features over the long text, and can notice the contextual features of context, thereby improving the classification effect of the long text. In addition, taking the second embedding vector matrix of the first generated word output by the first model as the input of the activation function layer can make the input of the activation function layer simpler and more controllable, thus ensuring the controllability of the output content of the target text classification model and further improving the text classification effect.

Hereinafter, a specific embodiment of inputting the first text into the first model of the target text classification model to obtain a second embedding vector matrix of the first generated word output by the first model in S202 is described in detail. Specifically, it may be realized by various embodiments, and in an embodiment, it may be realized by the following steps (b1) to (b3).

Step (b1): acquiring a prompt text.

In the present disclosure, the prompt text used in the inference stage of the target text classification model is consistent with the classification text used during the training of the target text classification model.

Step (b2): concatenating the prompt text with the first text to obtain a second concatenated text, and performing tokenization on the second concatenated text to obtain a second token result.

In the present disclosure, the prompt text and the first text may be concatenated in the order of the prompt text first and the first text second, or the prompt text and the first text may be concatenated in the order of the first text first and the prompt text second, and the present disclosure does not specifically limit the concatenation order of the prompt text and the first text, as long as the concatenation order of the prompt text and the text sample remains consistent with the concatenation order of the prompt text and the first text.

Step (b3): inputting the second token result to the first model of the target text classification model to obtain the second embedding vector matrix.

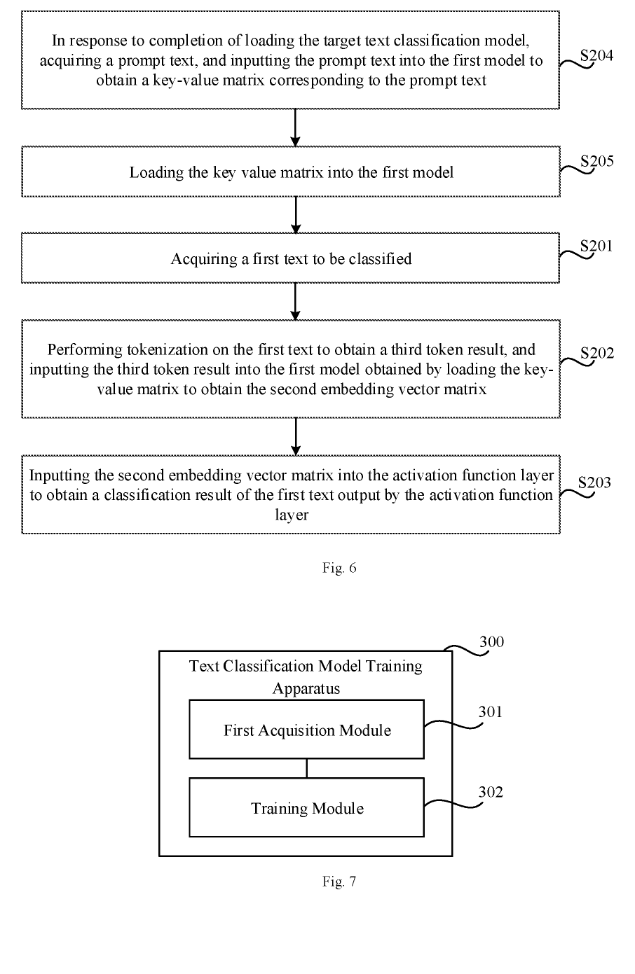

In another embodiment, as shown in FIG. 6, the above-described text classification method may further include the following S204 and S205.

In S204, in response to completion of loading the target text classification model, a prompt text is acquired, and the prompt text is input into the first model to obtain a key-value matrix corresponding to the prompt text.

In the present disclosure, the key-value matrix is a key and value matrix of the prompt text, i.e., a k-matrix and a v-matrix.

In S205, the key value matrix is loaded into the first model.

At this time, inputting the first text into the first model of the target text classification model to obtain the second embedding vector matrix of the first generated word output by the first model may include:

performing tokenization on the first text to obtain a third token result; and

inputting the third token result into the first model obtained by loading the key-value matrix to obtain the second embedding vector matrix.

In the above embodiment, by adopting the concept of Key-Value Cache, the key-value matrix of the prompt text is determined in advance and is preloaded into the first model before the target text classification model performs inference. As a result, during the inference stage of the target text classification model, only the first text needs to be input into the model, without the need to input the prompt text, thereby reducing the repeated computation of the k-matrix and v-matrix of the prompt text, reducing the model inference time, and improving the inference efficiency of the model.

In a possible embodiment, the target text classification model further includes a first fully connected layer, a concatenation layer, and a second fully connected layer.

The above text classification method may further include:

acquiring a second statistical feature of the first text.

At this time, inputting the second embedding vector matrix into the activation function layer to obtain the classification result of the first text output by the activation function layer may include:

upscaling the second statistical feature to the size of the second embedding vector matrix through the first fully connected layer;

concatenating the second statistical feature obtained after upscaling with the second embedding vector matrix through the concatenation layer to obtain a second concatenated feature;

performing feature fusion on the second concatenated feature through the second fully connected layer to obtain a second fused feature; and

generating the classification result of the first text based on the second fused feature through the activation function layer.

In a possible embodiment, the second statistical feature includes at least one of the following: a text length, a proportion of texts in different languages, a proportion of numbers, a proportion of commonly used punctuation marks, or a proportion of special symbols.

FIG. 7 is a block diagram of a text classification model training apparatus according to an exemplary embodiment. The text classification model includes a first model and an activation function layer, and the first model is a pre-trained large language model. As shown in FIG. 7, the text classification model training apparatus 300 may include:

a first acquisition module 301, configured to acquire a training sample set and a prompt text, where a training sample in the training sample set includes a text sample and a classification label corresponding to the text sample, and the prompt text includes classification task description information of the text classification model; and

a training module 302, configured to train the text activation function to obtain a target text classification model by using the prompt text and the text sample as an input of the first model, using a first embedding vector matrix of a first generated word output by the first model as an input of the activation function layer, and using the classification label corresponding to the text sample as a target output of the activation function layer.

In the above technical solution, the text classification model includes a first model and an activation function layer, where the first model is a pre-trained large language model. Because the large language model is suitable for processing the long text and is capable of capturing long-distance contextual features, the text classification model can support the classification of the long text, so that the trained target text classification model can also have the ability to capture long-distance contextual features over the long text, and can notice the contextual features of context, thereby improving the classification effect of the long text. In addition, the large language model has a larger amount of pre-trained corpus, which can compress more knowledge in the model, and can be tuned in combination with prompt engineering, which greatly improves the classification capabilities of target text classification model. In addition, taking the first embedding vector matrix of the first generated word output by the first model as the input of the activation function layer can make the input of the activation function layer simpler and more controllable, thereby ensuring the controllability of the output content of the text classification model and further improving the classification ability of the model.

Optionally, the text classification model further includes a first fully connected layer, a concatenation layer, and a second fully connected layer.

The text classification model training apparatus 300 further includes:

a second acquisition module, configured to acquire a first statistical feature of the text sample,

where the first model is configured to generate the first embedding vector matrix according to the prompt text and the text sample, and input the first embedding vector matrix to the concatenation layer;

the first fully connected layer is configured to upscale the first statistical feature to a size of the first embedding vector matrix, and input the first statistical feature obtained after upscaling to the concatenation layer;

the concatenation layer is configured to concatenate the first statistical feature obtained after upscaling with the first embedding vector matrix to obtain a first concatenated feature, and input the first concatenated feature to the second fully connected layer;

the second fully connected layer is configured to perform feature fusion on the first concatenated feature to obtain a first fusion feature, and input the first fusion feature to the activation function layer;

the activation function layer is configured to generate a classification result of the text sample according to the first fusion feature.

Optionally, the training module 302 is configured to train the text classification model to obtain the target text classification model by using the prompt text and the text sample as the input of the first model, using the first statistical feature as an input of the first fully connected layer, using the first embedding vector matrix of a first generated word output by the first model and an output of the first fully connected layer as an input of the concatenation layer, using an output of the concatenation layer as an input of the second fully connected layer, using an output of the second fully connected layer as the input of the activation function layer, and using the classification label corresponding to the text sample as an target output of the activation function layer.

Optionally, the first statistical feature includes at least one of the following: a text length, a proportion of texts in different languages, a proportion of numbers, a proportion of commonly used punctuation marks, or a proportion of special symbols.

Optionally, the prompt text further includes example information for guiding the text classification model to output a classification label.

Optionally, the text classification model is trained by using at least one of the following training strategies:

stepwise increasing a learning rate of the first model;

adjusting model parameters of partial layers of the first model; or

setting different learning rates for different layers of the text classification model.

Optionally, the training module 302 includes:

a first concatenation sub-module, configured to concatenate the prompt text with the text sample to obtain a first concatenated text, and performing tokenization on the first concatenated text to obtain a first token result; and

a determination sub-module, configured to use the first token result as an input to the first model.

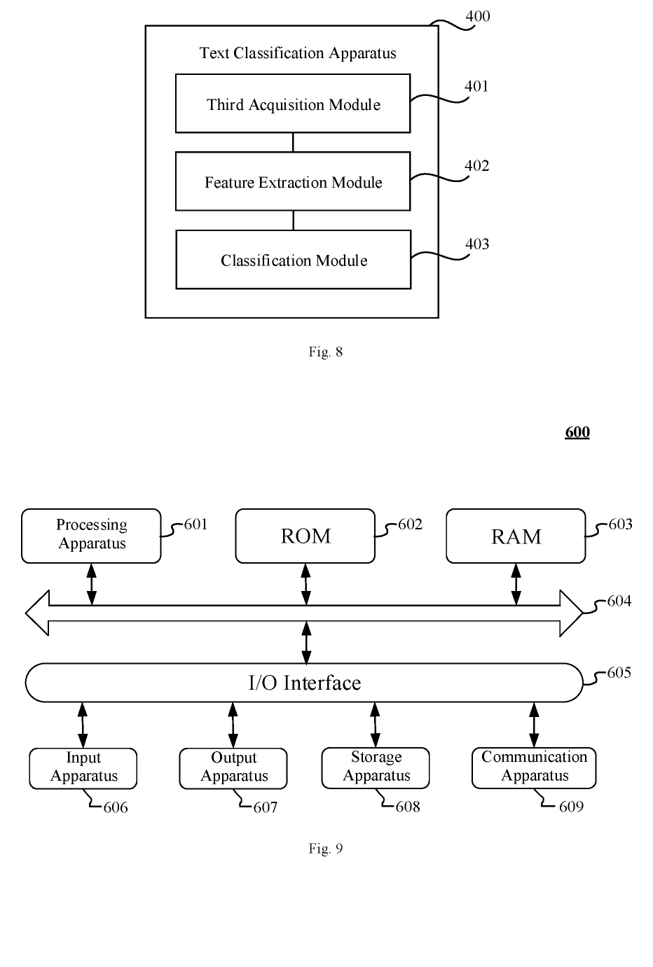

FIG. 8 is a block diagram of a text classification apparatus according to an exemplary embodiment. As shown in FIG. 8, the text classification apparatus 400 includes:

a third acquisition module 401, configured to acquire a first text to be classified;

a feature extraction module 402, configured to input the first text into a first model of a target text classification model to obtain a second embedding vector matrix of a first generated word output by the first model, where the target text classification model includes the first model and an activation function layer, and the first model is a large language model; and

a classification module 403, configured to input the second embedding vector matrix into the activation function layer to obtain a classification result of the first text output by the activation function layer.

In the present embodiment, the target text classification model includes a first model and an activation function layer, where the first model is a large language model. Because the large language model is suitable for processing the long text and is capable of capturing long-distance contextual features, the target text classification model can support the classification of the long text, so that the target text classification model can also have the ability to capture long-distance contextual features over the long text, and can notice the contextual features of context, thereby improving the classification effect of the long text. In addition, taking the second embedding vector matrix of the first generated word output by the first model as the input of the activation function layer can make the input of the activation function layer simpler and more controllable, thus ensuring the controllability of the output content of the target text classification model and further improving the text classification effect.

Optionally, the feature extraction module 402 includes:

an acquisition sub-module, configured to acquire a prompt text;

a second concatenation sub-module, configured to concatenate the prompt text with the first text to obtain a second concatenated text, and perform tokenization on the second concatenated text to obtain a second token result; and

a first feature extraction sub-module, configured to input the second token result to a first model of a target text classification model to obtain the second embedding vector matrix.

Optionally, the text classification apparatus 400 further includes:

a fourth acquisition module, configured to, in response to completion of loading the target text classification model, acquire a prompt text, and input the prompt text into the first model to obtain a key-value matrix corresponding to the prompt text; and

a loading module, configured to load the key-value matrix into the first model;

the feature extraction module 402 includes:

a tokenization sub-module, configured to perform tokenization on the first text to obtain a third token result;

a second feature extraction sub-module, configured to input the third token result into the first model obtained by loading the key-value matrix to obtain the second embedding vector matrix.

Optionally, the target text classification model further includes a first fully connected layer, a concatenation layer, and a second fully connected layer;

the text classification apparatus 400 further includes:

a fifth acquisition module, configured to acquire a second statistical feature of the first text ;

the classification module 403 includes:

an upscaling submodule, configured to upscale the second statistical feature to a size of the second embedding vector matrix through the first fully connected layer;

a third concatenation sub-module, configured to concatenate the second statistical feature obtained after upscaling with the second embedding vector matrix through the concatenation layer to obtain a second concatenated feature;

a feature fusion sub-module, configured to perform feature fusion on the second concatenated feature through the second fully connected layer to obtain a second fused feature; and

a classification sub-module, configured to generate the classification result of the first text based on the second fused feature through the activation function layer.

Optionally, the second statistical feature includes at least one of the following: a text length, a proportion of texts in different languages, a proportion of numbers, a proportion of commonly used punctuation marks, or a proportion of special symbols.

In addition, the present disclosure also provides a non-transitory computer-readable storage medium storing computer programs thereon. The computer programs, upon being executed by at least one processor, implement the steps of the above-described text classification model training method provided by the present disclosure or the steps of the above-described text classification method provided by the present disclosure.

The present disclosure further provides an electronic device, which includes:

at least one memory, having computer program stored thereon; and

at least one processor, configured to execute the computer programs in the at least one memory to implement the steps of the text classification model training method or the steps of the text classification method provided by the present disclosure.

The present disclosure further provides a computer program product, which includes computer programs. The computer programs, upon being executed by a processor, implement the steps the above-described text classification model training method provided by the present disclosure or the steps of the above-described text classification method provided by the present disclosure.

Referring to FIG. 9, FIG. 9 illustrates a structural schematic diagram of an electronic device (e.g. a terminal device or a server) 600 suitable for implementing embodiments of the present disclosure. The terminal device in embodiments of the present disclosure may include but not limited to a mobile terminal such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 9 is merely an example, and should not pose any limitation to the functions and the range of use of the embodiments of the present disclosure.

As illustrated in FIG. 9, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Generally, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. Although FIG. 9 illustrates the electronic device 600 having various apparatuses, it should be understood that not all of the illustrated apparatuses are necessarily implemented or included. More or fewer apparatuses may be implemented or included alternatively.

Particularly, according to embodiments of the present disclosure, the processes described above with reference to the flowcharts may be implemented as a computer software program. For example, an embodiment of the present disclosure includes a computer program product, which includes computer programs carried by a non-transitory computer-readable medium. The computer programs include program codes for performing the methods shown in the flowcharts. In such embodiments, the computer program may be downloaded and installed from the network through the communication apparatus 609, or may be installed from the storage apparatus 608, or may be installed from the ROM 602. When the computer programs are executed by the processing apparatus 601, the above-mentioned functions defined in the methods of embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some embodiments, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: acquire a training sample set and a prompt text, where a training sample in the training sample set includes a text sample and a classification label corresponding to the text sample, and the prompt text includes classification task description information of the text classification model; and train the text classification model to obtain a target text classification model by using the prompt text and the text sample as an input of the first model, using a first embedding vector matrix of a first generated word output by the first model as an input of the activation function layer, and using the classification label corresponding to the text sample as a target output of the activation function layer.

Alternatively, the above-mentioned computer-readable medium carries one or more programs, and when the one or more programs are executed by the electronic device, the electronic device is caused to: acquire a first text to be classified; input the first text into a first model of a target text classification model to obtain a second embedding vector matrix of a first generated word output by the first model, where the target text classification model includes the first model and an activation function layer, and the first model is a large language model; and input the second embedding vector matrix into the activation function layer to obtain a classification result of the first text output by the activation function layer.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user’s computer, partly on the user’s computer, as a stand-alone software package, partly on the user’s computer and partly on a remote computer, or entirely on the remote computer or server. In the scenario related to the remote computer, the remote computer may be connected to the user’s computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. The name of the module does not constitute a limitation of the unit itself under certain circumstances. For example, the first acquisition module may also be described as a “module for acquiring a training sample set and a prompt text”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides a text classification model training method, where the text classification model includes a first model and an activation function layer, the first model is a pre-trained large language model, and the text classification model training method includes:

acquiring a training sample set and a prompt text, where a training sample in the training sample set includes a text sample and a classification label corresponding to the text sample, and the prompt text includes classification task description information of the text classification model; and

training the text classification model to obtain a target text classification model by using the prompt text and the text sample as an input of the first model, using a first embedding vector matrix of a first generated word output by the first model as an input of the activation function layer, and using the classification label corresponding to the text sample as a target output of the activation function layer.

According to one or more embodiments of the present disclosure, Example 2 provides the text classification model training method of Example 1, where the text classification model further includes a first fully connected layer, a concatenation layer, and a second fully connected layer;

the text classification model training method further includes:

acquiring a first statistical feature of the text sample,

where the first model is configured to generate the first embedding vector matrix according to the prompt text and the text sample, and input the first embedding vector matrix to the concatenation layer;

the first fully connected layer is configured to upscale the first statistical feature to a size of the first embedding vector matrix, and input the first statistical feature obtained after upscaling to the concatenation layer;

the concatenation layer is configured to concatenate the first statistical feature obtained after upscaling with the first embedding vector matrix to obtain a first concatenated feature, and input the first concatenated feature to the second fully connected layer;

the second fully connected layer is configured to perform feature fusion on the first concatenated feature to obtain a first fusion feature, and input the first fusion feature to the activation function layer; and

the activation function layer is configured to generate a classification result of the text sample according to the first fusion feature.

According to one or more embodiments of the present disclosure, Example 3 provides the text classification model training method of Example 2, where the training the text classification model to obtain a target text classification model by using the prompt text and the text sample as an input of the first model, using a first embedding vector matrix of a first generated word output by the first model as an input of the activation function layer, and using the classification label corresponding to the text sample as a target output of the activation function layer, includes:

training the text classification model to obtain the target text classification model by using the prompt text and the text sample as the input of the first model, using the first statistical feature as an input of the first fully connected layer, using the first embedding vector matrix of a first generated word output by the first model and an output of the first fully connected layer as an input of the concatenation layer, using an output of the concatenation layer as an input of the second fully connected layer, using an output of the second fully connected layer as the input of the activation function layer, and using the classification label corresponding to the text sample as an target output of the activation function layer.

According to one or more embodiments of the present disclosure, Example 4 provides the text classification model training method of Example 2, where the first statistical feature includes at least one of the following: a text length, a proportion of texts in different languages, a proportion of numbers, a proportion of commonly used punctuation marks, or a proportion of special symbols.

According to one or more embodiments of the present disclosure, Example 5 provides the text classification model training method of any one of Examples 1-4, where the prompt text further includes example information for guiding the text classification model to output a classification label.

According to one or more embodiments of the present disclosure, Example 6 provides the text classification model training method of any one of Examples 1-4, where the text classification model is trained by using at least one of the following training strategies:

stepwise increasing a learning rate of the first model;

adjusting model parameters of partial layers of the first model; or

setting different learning rates for different layers of the text classification model.

According to one or more embodiments of the present disclosure, Example 7 provides the text classification model training method of any one of Examples 1-4, where the using the prompt text and the text sample as an input of the first model includes:

concatenating the prompt text with the text sample to obtain a first concatenated text, and performing tokenization on the first concatenated text to obtain a first token result; and

using the first token result as an input to the first model.

According to one or more embodiments of the present disclosure, Example 8 provides a text classification method, which includes:

acquiring a first text to be classified;

inputting the first text into a first model of a target text classification model to obtain a second embedding vector matrix of a first generated word output by the first model, where the target text classification model includes the first model and an activation function layer, and the first model is a large language model; and

inputting the second embedding vector matrix into the activation function layer to obtain a classification result of the first text output by the activation function layer.

According to one or more embodiments of the present disclosure, Example 9 provides the text classification method of Example 8, where the inputting the first text into a first model of a target text classification model to obtain a second embedding vector matrix of a first generated word output by the first model, includes:

acquiring a prompt text;

concatenating the prompt text with the first text to obtain a second concatenated text, and performing tokenization on the second concatenated text to obtain a second token result; and

inputting the second token result to the first model of the target text classification model to obtain the second embedding vector matrix.

According to one or more embodiments of the present disclosure, Example 10 provides the text classification method of Example 8, further including:

in response to completion of loading the target text classification model, acquiring a prompt text, and inputting the prompt text into the first model to obtain a key-value matrix corresponding to the prompt text; and

loading the key-value matrix into the first model;

the inputting the first text into a first model of a target text classification model to obtain a second embedding vector matrix of a first generated word output by the first model, includes:

performing tokenization on the first text to obtain a third token result; and

inputting the third token result into the first model obtained by loading the key-value matrix to obtain the second embedding vector matrix.

According to one or more embodiments of the present disclosure, Example 11 provides the text classification method of any one of Examples 8-10, where the target text classification model further includes a first fully connected layer, a concatenation layer, and a second fully connected layer;

the text classification method further includes:

acquiring a second statistical feature of the first text;

the inputting the second embedding vector matrix into the activation function layer to obtain a classification result of the first text output by the activation function layer, includes:

upscaling the second statistical feature to a size of the second embedding vector matrix through the first fully connected layer;

concatenating the second statistical feature obtained after upscaling with the second embedding vector matrix through the concatenation layer to obtain a second concatenated feature;

performing feature fusion on the second concatenated feature through the second fully connected layer to obtain a second fused feature; and

generating the classification result of the first text based on the second fused feature through the activation function layer.

According to one or more embodiments of the present disclosure, Example 12 provides the text classification method of Example 11, where the second statistical feature includes at least one of the following: a text length, a proportion of texts in different languages, a proportion of numbers, a proportion of commonly used punctuation marks, or a proportion of special symbols.

According to one or more embodiments of the present disclosure, Example 13 provides a non-transitory computer-readable storage medium having computer programs stored thereon, where the computer programs, upon being executed by at least one processor, implement the steps of the text classification model training method of any one of Examples 1-7 or the steps of the text classification method of any one of Examples 8-12.

According to one or more embodiments of the present disclosure, Example 14 provides an electronic device, which includes:

at least one memory, having computer programs stored thereon; and

at least one processor, configured to execute the computer programs in the at least one memory to implement the steps of the text classification model training method according to any one of Examples 1-7 or the steps of the text classification method according to any one of Examples 8-12.

According to one or more embodiments of the present disclosure, Example 15 provides a computer program product including computer programs, where the computer programs, upon being executed by a processor, implement the steps of the text classification model training method according to any one of Examples 1-7 or the steps of the text classification method according to any one of Examples 8-12.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims. With regard to the apparatus in the above-described embodiments, the specific manner in which the respective modules perform operations has been described in detail in the embodiments related to the method, and will not be described in detail here.

1. A text classification model training method, wherein the text classification model comprises a first model and an activation function layer, the first model is a pre-trained large language model, and the text classification model training method comprises:
acquiring a training sample set and a prompt text, wherein a training sample in the training sample set comprises a text sample and a classification label corresponding to the text sample, and the prompt text comprises classification task description information of the text classification model; and
training the text classification model to obtain a target text classification model by using the prompt text and the text sample as an input of the first model, using a first embedding vector matrix of a first generated word output by the first model as an input of the activation function layer, and using the classification label corresponding to the text sample as a target output of the activation function layer.

2. The text classification model training method according to claim 1, wherein the text classification model further comprises a first fully connected layer, a concatenation layer, and a second fully connected layer;
the text classification model training method further comprises:
acquiring a first statistical feature of the text sample,
wherein the first model is configured to generate the first embedding vector matrix according to the prompt text and the text sample, and input the first embedding vector matrix to the concatenation layer;
the first fully connected layer is configured to upscale the first statistical feature to a size of the first embedding vector matrix, and input the first statistical feature obtained after upscaling to the concatenation layer;
the concatenation layer is configured to concatenate the first statistical feature obtained after upscaling with the first embedding vector matrix to obtain a first concatenated feature, and input the first concatenated feature to the second fully connected layer;
the second fully connected layer is configured to perform feature fusion on the first concatenated feature to obtain a first fusion feature, and input the first fusion feature to the activation function layer; and
the activation function layer is configured to generate a classification result of the text sample according to the first fusion feature.

3. The text classification model training method according to claim 2, wherein the training the text classification model to obtain a target text classification model by using the prompt text and the text sample as an input of the first model, using a first embedding vector matrix of a first generated word output by the first model as an input of the activation function layer, and using the classification label corresponding to the text sample as a target output of the activation function layer, comprises:
training the text classification model to obtain the target text classification model by using the prompt text and the text sample as the input of the first model, using the first statistical feature as an input of the first fully connected layer, using the first embedding vector matrix of a first generated word output by the first model and an output of the first fully connected layer as an input of the concatenation layer, using an output of the concatenation layer as an input of the second fully connected layer, using an output of the second fully connected layer as the input of the activation function layer, and using the classification label corresponding to the text sample as an target output of the activation function layer.

4. The text classification model training method according to claim 2, wherein the first statistical feature comprises at least one selected from a group consisting of: a text length, a proportion of texts in different languages, a proportion of numbers, a proportion of commonly used punctuation marks, or a proportion of special symbols.

5. The text classification model training method according to claim 1, wherein the prompt text further comprises example information for guiding the text classification model to output a classification label.

6. The text classification model training method according to claim 1, wherein the text classification model is trained by using at least one of following training strategies:
stepwise increasing a learning rate of the first model;
adjusting model parameters of partial layers of the first model; or
setting different learning rates for different layers of the text classification model.

7. The text classification model training method according to claim 1, wherein the using the prompt text and the text sample as an input of the first model comprises:
concatenating the prompt text with the text sample to obtain a first concatenated text, and performing tokenization on the first concatenated text to obtain a first token result; and
using the first token result as an input to the first model.

8. The text classification model training method according to claim 2, wherein the using the prompt text and the text sample as an input of the first model comprises:
concatenating the prompt text with the text sample to obtain a first concatenated text, and performing tokenization on the first concatenated text to obtain a first token result; and
using the first token result as an input to the first model.

9. The text classification model training method according to claim 3, wherein the using the prompt text and the text sample as an input of the first model comprises:
concatenating the prompt text with the text sample to obtain a first concatenated text, and performing tokenization on the first concatenated text to obtain a first token result; and
using the first token result as an input to the first model.

10. The text classification model training method according to claim 4, wherein the using the prompt text and the text sample as an input of the first model comprises:
concatenating the prompt text with the text sample to obtain a first concatenated text, and performing tokenization on the first concatenated text to obtain a first token result; and
using the first token result as an input to the first model.

11. A text classification method, comprising:
acquiring a first text to be classified;
inputting the first text into a first model of a target text classification model to obtain a second embedding vector matrix of a first generated word output by the first model, wherein the target text classification model comprises the first model and an activation function layer, and the first model is a large language model; and
inputting the second embedding vector matrix into the activation function layer to obtain a classification result of the first text output by the activation function layer.

12. The text classification method according to claim 11, wherein the inputting the first text into a first model of a target text classification model to obtain a second embedding vector matrix of a first generated word output by the first model, comprises:
acquiring a prompt text;
concatenating the prompt text with the first text to obtain a second concatenated text, and performing tokenization on the second concatenated text to obtain a second token result; and
inputting the second token result to the first model of the target text classification model to obtain the second embedding vector matrix.

13. The text classification method of claim 11, further comprising:
in response to completion of loading the target text classification model, acquiring a prompt text, and inputting the prompt text into the first model to obtain a key-value matrix corresponding to the prompt text; and
loading the key-value matrix into the first model;
the inputting the first text into a first model of a target text classification model to obtain a second embedding vector matrix of a first generated word output by the first model, comprises:
performing tokenization on the first text to obtain a third token result; and
inputting the third token result into the first model obtained by loading the key-value matrix to obtain the second embedding vector matrix.

14. The text classification method according to claim 11, wherein the target text classification model further comprises a first fully connected layer, a concatenation layer, and a second fully connected layer;
the text classification method further comprises:
acquiring a second statistical feature of the first text;
the inputting the second embedding vector matrix into the activation function layer to obtain a classification result of the first text output by the activation function layer, comprises:
upscaling the second statistical feature to a size of the second embedding vector matrix through the first fully connected layer;
concatenating the second statistical feature obtained after upscaling with the second embedding vector matrix through the concatenation layer to obtain a second concatenated feature;
performing feature fusion on the second concatenated feature through the second fully connected layer to obtain a second fused feature; and
generating the classification result of the first text based on the second fused feature through the activation function layer.

15. The text classification method according to claim 12, wherein the target text classification model further comprises a first fully connected layer, a concatenation layer, and a second fully connected layer;
the text classification method further comprises:
acquiring a second statistical feature of the first text;
the inputting the second embedding vector matrix into the activation function layer to obtain a classification result of the first text output by the activation function layer, comprises:
upscaling the second statistical feature to a size of the second embedding vector matrix through the first fully connected layer;
concatenating the second statistical feature obtained after upscaling with the second embedding vector matrix through the concatenation layer to obtain a second concatenated feature;
performing feature fusion on the second concatenated feature through the second fully connected layer to obtain a second fused feature; and
generating the classification result of the first text based on the second fused feature through the activation function layer.

16. The text classification method according to claim 14, wherein the second statistical feature comprises at least one selected from a group consisting of: a text length, a proportion of texts in different languages, a proportion of numbers, a proportion of commonly used punctuation marks, or a proportion of special symbols.

17. A non-transitory computer-readable storage medium, having computer programs stored thereon, wherein the computer programs, upon being executed by at least one processor, implement the text classification model training method according to claim 1.

18. A non-transitory computer-readable storage medium, having computer programs stored thereon, wherein the computer programs, upon being executed by at least one processor, implement the text classification method according to claim 11.

19. An electronic device, comprising:
at least one memory, having computer programs stored thereon; and
at least one processor, configured to execute the computer programs in the at least one memory to implement the text classification model training method according to claim 1.

20. An electronic device, comprising:
at least one memory, having computer programs stored thereon; and
at least one processor, configured to execute the computer programs in the at least one memory to implement the text classification method according to claim 11.
